(19) United States
(12) Patent Application Publication
(10) Pub. No.: US 2016/0200945 A1
(43) Pub. Date: Jul. 14, 2016

(54) One Degree of Freedom Climbing Robot with Anisotropic Directional Dry Adhesion

(71) Applicant: The Board of Trustees of the Leland Stanford Junior University, Palo Alto, CA (US)

(72) Inventors: Elliot W. Hawkes, San Francsco, CA (US); David L. Christensen, Los Altos, CA (US); Mark R. Cutkosky, Palo Alto, CA (US)

(21) Appl. No.: 14/926,728

(22) Filed: Oct. 29, 2015

Related U.S. Application Data
(60) Provisional application No. 62/103,184, filed on Jan. 14, 2015.

(51) Int. Cl. C09J 7/02

(52) U.S. Cl. CPC C09J 7/02; C09J 2483/00; C09J 2415/00

(57) ABSTRACT

A one-way synthetic dry adhesive is provided that includes a dry adhesive material layer having an array of microwedges, where the dry adhesive layer is disposed on a substrate surface. The microwedges have a leading surface and a trailing surface, where the leading surface terminates into the trailing surface to form a wedge tip. The leading surface includes an angle up to 90 degrees with respect to the substrate surface, and the trailing edge surface includes an angle greater than the leading surface angle with respect to the substrate. The microwedges have a depth that is less than a thickness of the dry adhesive layer, and a series of siping features disposed in the dry adhesive layer, where a depth of the siping features is greater than the microwedge depth, and the series of siping features has a periodicity that is less than a periodicity of the array of microwedges.

### CROSS-REFERENCE TO RELATED APPLICATIONS

This application claims priority from U.S. Provisional Patent Application 62/103184 filed Jan. 14, 2015, which is incorporated herein by reference.

### STATEMENT OF GOVERNMENT SPONSORED SUPPORT

This invention was made with Government support under grant no. HR0011-12-C-0040 awarded by the Defense Advanced Research Project Agency, and under contract DGE-114747 awarded by the National Science Foundation. The Government has certain rights in the invention.

### FIELD OF THE INVENTION

This invention relates generally to climbing robots. More specifically, the invention relates to climbing robots using anisotropic directional dry adhesives.

### BACKGROUND OF THE INVENTION

Many insects are capable of exerting forces equivalent to many times their bodyweight. For instance, the Asian Weaver Ant (Oecophylla smaragdina) is capable of sustaining adhesion forces of over 100 times its own bodyweight, and with these forces has been documented to transport large vertebrate prey. There are two crucial characteristics of insects that are capable of applying large forces, yet still easily locomote. First, they have incredible strength for their weight, or force density. Second, they have controllable adhesion that can support large loads, yet can release easily from the surface when desired. Without controllable adhesion, which can be switched on and off, small climbers would not be able to both apply large forces to objects and lift their feet to climb without exerting the same large forces at each step.

Previous adhesive climbing robots, while exhibiting impressive climbing, and in some cases maneuverability, have not come close to meeting the hoisting ability (defined here as payload normalized by bodyweight) of the weaver ant. One previous climbing robot could lift no more than 1 time its bodyweight. Another robot could climb with 1.17 times its bodyweight. In the realm of miniature adhesive, climbing robots, defined here as less than 40 mm per side, only one example exists, which climbed with smooth rubber tank-treads. It is the smallest vertical surface dry adhesive climber to date (10 g). The robot was built to carry no more than 3 times is weight, and was tested up to a single bodyweight.

A small robot with the ability to hoist large loads could have countless applications not only in the oft-cited role as a small, cheap, disposable, mobile sensor in the realms of search and rescue, surveillance, and environmental monitoring, but also as an actor that could alter its environment.

Instead of observing an event, a tiny robot that can produce huge forces could affect the event. For example, it could (possibly in a team) carry a rope ladder to person trapped on the fifth floor of a burning building, or carry equipment and fix the crack it discovers in a dam or bridge.

What is needed is a miniature, climbing robot that maximizes hoisting ability using controllable anisotropic adhesion.

### SUMMARY OF THE INVENTION

To address the needs in the art, a one-way synthetic dry adhesive is provided that includes a dry adhesive material layer comprising an array of microwedges, where the dry adhesive material layer is disposed on a substrate surface, where the microwedges have a leading surface and a trailing surface, where the leading surface terminates into the trailing surface to form a wedge tip, and the leading surface includes an angle up to 90 degrees with respect to the substrate surface, where the trailing edge surface includes an angle greater than the leading surface angle with respect to the substrate surface, where the microwedges have a depth that is less than a thickness of the dry adhesive material layer, and a series of siping features disposed in the dry adhesive material layer, where a depth of the siping features is greater than the microwedge depth, where the series of siping features has a periodicity that is less than a periodicity of the array of microwedges.

In one aspect of the invention, the dry adhesive material can be Polydimethylsiloxane (PDMS), silicone rubbers, urethane rubbers, thermoplastics, or thermosetting polymers.

In another aspect of the invention, the siping features include an angle that is up to 90 degrees with respect to the substrate surface.

According to a further aspect of the invention, the siping feature is closed when in a load-state of the one-way synthetic dry adhesive, where the siping feature is open when in an unload-state of the one-way synthetic dry adhesive. In one aspect, when in the load-state the microwedges increase contact with a climbing surface with respect to a static state, and when in the unload-state the microwedges decrease contact with the climbing surface with respect to the static state.

In another aspect, the invention further includes a connector spanning from the substrate to a second substrate of a second the one-way synthetic dry adhesive. In one aspect, the connector can be an elastic tendon, a spring, a 1-dimensional actuator, a motor, or a linkage.

### BRIEF DESCRIPTION OF THE DRAWINGS

FIG. 1 shows a miniature 9 g climber hoisting other climbing robots, where the inset is a view from the ceiling, looking down at the robots, according to one embodiment of the invention.

FIG. 2 shows a single degree of freedom, linear inchworm climbing gait, according to one embodiment of the invention.

FIGS. 3A-3C show (FIG. 3A) only the tips of the wedges engage with the surface at initial contact, (FIG. 3B) When loaded in shear, the contact area, and thus the adhesion greatly increases, (FIG. 3C) when unloaded, the contact area decreases as the wedges return to their neutral state, and the adhesion decreases to nearly zero, according to one embodiment of the invention.

FIG. 4 shows the limit curve of controllable microwedge adhesive. Positive shear values represent forces applied by the climber down the wall. Negative normal values are adhesion forces applied by the climber into the wall. Note the symmetry of the limit in positive and negative shear. Such symmetry means that the adhesive cannot slide up the wall, unless a method is used to create anisotropic adhesion. Also note that when the shear load is removed, the normal load capacity drops to nearly zero. This effect means that the adhesive can be removed from the wall with nearly no normal force, according to one embodiment of the invention.

FIGS. 5A-5C show (FIG. 5A) drawing of the inchworm dry adhesive climbing gait for the 9 g robot. 1) The bottom pad bears the load. 2) The top pad rotates away from the wall when unloaded, and translates upwards (see FIG. 5B detail). 3) The top pad reaches the extent of its travel and begins to take load, coming into contact (see FIG. 5C detail). 4) The top pad takes the entirety of the load, and the lower pad rotates away from the wall and translates upward. (FIG. 5B) detail of pad lifting. The offset of the attachment points of the tendons (top tendon further from wall) forces a pad to rotate away from the wall when tension is equal in both tendons. (FIG. 5C) detail of pad engaging. In contrast, when the tension in the top tendon is much less than that in the bottom tendon, the pad rotates into the wall, due to the moment generated by the shear adhesion at the surface and the bottom tendon, according to one embodiment of the invention.

FIGS. 6A-6C show (FIG. 6A) In order to allow the adhesive to move up the wall for the 20 mg robot, a new method of creating a one-way adhesive was developed using siping (dotted line). (FIG. 6B) The cut remains closed during preferred direction loading, leaving performance unaffected. (FIG. 6C) However, when loaded in the non-preferred direction, the cut opens, lifting the majority of the adhesive off of the surface. This greatly decreases adhesion. Siping can be done periodically to control the number of wedges in contact when loaded in the nonpreferred direction, according to one embodiment of the invention.

FIG. 7 shows the force-displacement curve of the return spring. It is desirable to have a nearly constant force that is slightly larger than the small shear force that is required to slide the pad up the wall, according to one embodiment of the invention.

FIGS. 8A-8B show the 9 g climber, according to one embodiment of the invention.

FIG. 9 shows the 20 mg climber, according to one embodiment of the invention.

FIG. 10 shows force data from a step of the 9 g climber on a vertical surface, according to one embodiment of the invention.

FIG. 11 shows force and displacement data from anisotropic adhesion testing. Blue squares show a siped pad loaded in the preferred direction. Crosses show a non-siped pad loaded in the non-preferred direction. Stars show a siped pad in the non-preferred direction. Siping greatly reduces the shear adhesion in the non-preferred direction, according to one embodiment of the invention.

FIG. 12 shows frames from a video of the 9 g climber showing robustness to missed steps. The top foot is made to not engage, but the robot does not fall, but rather attempts a second time and succeeds, according to one embodiment of the invention.

FIG. 13 shows in circles, data showing the power required for the 9 g robot to carry various loads. In diamonds the power delivered by commercially available solar units. If the power per weight roughly scales linearly, only 50 g of solar cells is required to climb continuously with a 1000 g payload. Hoisting a full payload of solar cells would provide 14 W of power beyond what the robot requires for climbing, according to one embodiment of the invention.

### DETAILED DESCRIPTION OF THE INVENTION

The ability to carry large payloads could greatly increase the functionality of small, low cost climbing robots. According to the current invention, in order to maximize the hoisting capability, robot mass is minimized, while maintaining climbing functionality. In one embodiment, the invention includes a single degree of freedom, linear inchworm gait made possible by anisotropic adhesion. With controllable, anisotropic adhesion, the gait is robust to missed steps. In addition, the gait provides a stance in which the robot can rest without requiring power. An autonomous 9 gram robot by the inventors was able to climb a smooth vertical surface at 3 mm/s, while hoisting more than a kilogram. An exemplary scaled down version of the robot is provided herein, which is considerably smaller than any previous dry adhesive climbing mechanism. In this embodiment, the robot is actuated by externally powered Shape Memory Alloy, weighing 20 mg, and is capable of hoisting 500 mg. These robots show that a large hoisting ability while climbing can be achieved using dry adhesives, and the presented embodiments further the development of autonomous, highly functional, small robots.

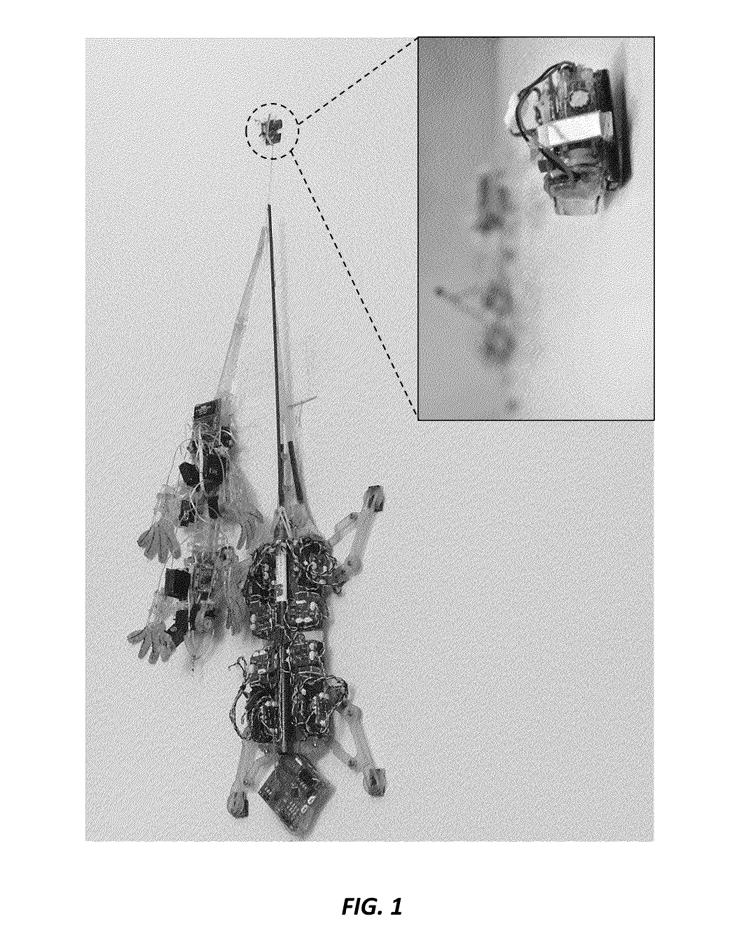

The inventors herein provide climbing robots having controllable, anisotropic adhesion, which enable a 1-degree of freedom inchworm climbing gait. In one embodiment, anisotropy applies moments to an adhesive pad to decrease the contact area and thus adhesion, and relies on siping of the adhesive material to yield the same result. The gait displays robustness to missed steps; a climber does not fall, but rather remains in place and attempts another step. The climber is able to support the entire payload without power when adhered with its lower pad. In another embodiment, a gait on two climbers is provided. The first is a 9 g robot with onboard power and control, which uses a single servo to climb while hoisting a kilogram up a smooth vertical surface (see FIG. 1). The second shows further miniaturization; it is an externally powered 20 mg climber that uses Shape Memory Alloy (SMA) as its actuator.

In another embodiment the one-way synthetic dry adhesive includes a dry adhesive material layer having an array of microwedges, where the dry adhesive material layer is disposed on a substrate surface. The microwedges have a leading surface and a trailing surface, where the leading surface terminates into the trailing surface to form a wedge tip. The leading surface includes an angle up to 90 degrees with respect to the substrate surface, and the trailing edge surface includes an angle greater than the leading surface angle with respect to the substrate surface. The microwedges have a depth that is less than a thickness of the dry adhesive material layer, and a series of siping features disposed in the dry adhesive material layer, where a depth of the siping features is greater than the microwedge depth, and the series of siping features has a periodicity that is less than a periodicity of the array of microwedges.

In another aspect of the invention, the siping features include an angle that is up to 90 degrees with respect to the substrate surface. Further, the siping feature is closed when in a load-state of the one-way synthetic dry adhesive, where the siping feature is open when in an unload-state of the one-way synthetic dry adhesive. In one aspect, when in the load-state the microwedges increase contact with a climbing surface with respect to a static state, and when in the unload-state the microwedges decrease contact with the climbing surface with respect to the static state.

The current invention uses three important design principles to leverage these miniature climbing robots to maximize hoisting ability. First is a minimalist design, and second, a small size scale. These two design principles lead to a third, which is a minimal, scalable inchworm gait that is made possible by controllable, anisotropic adhesion.

Turning to the minimalist design, the design of the miniature robots can be compared to a climbing robot known in the art that is a 30 cm long, four-legged robot, where the total area of adhesive in contact with the surface during climbing is around 3 cm², yet the surface area of the underside of the robot is nearly 150 cm². With the goal of hoisting in mind, such a mismatch between the area of the adhesive and the total area is not desirable. Therefore, in the hoisting designs, the majority of the area of the robot is covered with load carrying adhesive.

The second part of the design to make the climbing robot compatible with large payloads is the configuration of the servos. In a prior art climbing robot, there are 16 servos controlling the gait of the four legs, yet only four of the motors are contributing to the upward propulsion of the robot. The other twelve servos are for controlling the gait pattern, allowing options for more complicated maneuvers than simple climbing, such as stepping over barriers or turning and climbing down, headfirst. For one embodiment of the current invention, these twelve non-hoisting servos are unnecessary. Further, of the remaining four servos, two are hoisting and two are swinging during a gait cycle. Ideally, in order to maximize load-carrying ability, no servo should be part of the load that another servo is hoisting. Thus according to the invention, a single servo is employed, leaving behind the other fifteen.

It has been previously argued that scaling the ability to climb with adhesion to large sizes is fundamentally difficult for two reasons: 1) the square-cube law dictates that with isometric scaling, the mass of an object goes as the cube of the length scale, while the adhesive area goes as the square, and 2) adhesive ability tends to drop off at larger scales, as exemplified by data from the gecko. For both of these reasons, the opposite is true: adhesive climbing at a small scale can yield impressive load carrying ability when normalized by bodyweight. Therefore, in order to match the hoisting ability of the ant it behooves the designer to work at as small a scale as possible.

One exemplary embodiment of the invention uses a 9 g scale for one of the climbers because it allows integration of a servo, circuit board, and battery, yet is small enough to match an ant's hoisting ability.

Regarding the inchworm gait, to attain the two design goals of minimalism and small size scale, a single degree of freedom, linear inchworm gait is chosen. The novelty of the gait presented here, is that it allows a robot to climb up a smooth vertical surface using controllable dry adhesives, while supporting large loads, resisting falls due to missed steps, and parking without power consumption.

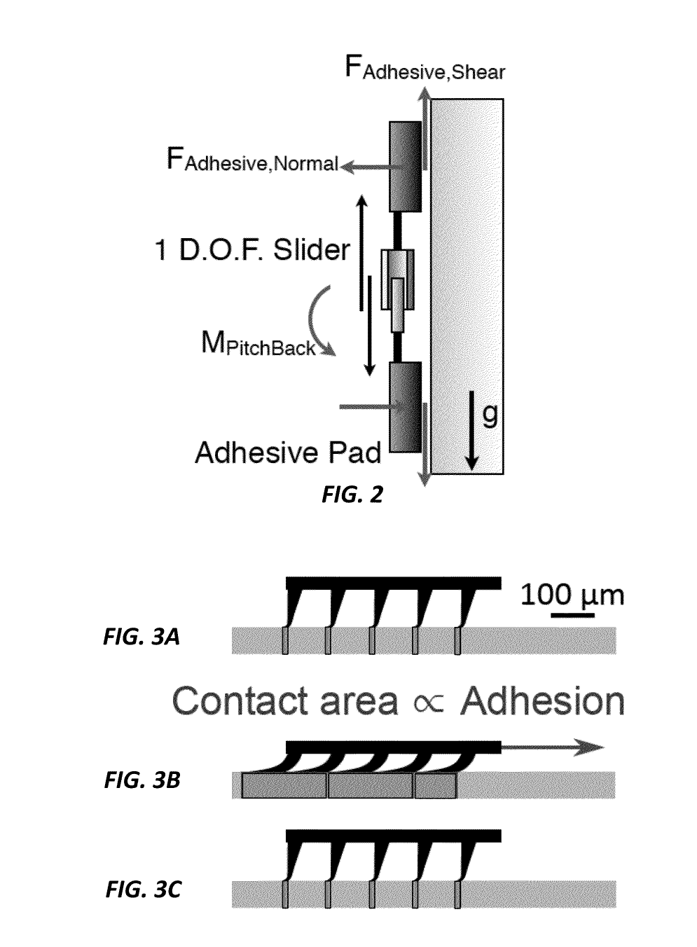

The gait, according to one embodiment, involves two adhesive pads that are able to move with respect to one another (see FIG. 2), where one pad supports the load, the other moves up the wall. While this inchworm gait is conceptually very simple, the subtleties of achieving the gait on a vertical surface while providing very large adhesive forces are more complex.

One challenge is loading the adhesive uniformly to achieve the maximum possible adhesion. This is done through the use of a rigid adhesive pad and a tendon that loads the pad through its center of pressure. The payload is supported by this tendon, which avoids the moment that tends to pitch climbing robots backward (see FIG. 2). The connective element between the pads can be an elastic tendon, a spring, a 1-dimensional actuator, a motor, or a linkage.

The second problem is sticking and unsticking the adhesive. Most adhesives, including many dry adhesives, require pressure in the normal direction to stick. With only a single degree of freedom, a linkage is required to press one adhesive pad into the surface while removing the other, all while progressing the robot up the wall. To avoid the use of a linkage, which adds weight to the robot, a controllable adhesive (capable of being turned on and off with the application of shear force), is used. In one embodiment, the adhesive is Polydimethylsiloxane (PDMS) microwedges. The dry adhesive material can also be silicone rubbers, urethane rubbers, thermoplastics, or thermosetting polymers. When loaded in shear (along the surface) the adhesives pull themselves into contact, resulting in large adhesion (see FIGS. 3A-3C), but when unloaded, the adhesive can be easily removed from the surface. Here, controllability is established by the robot transferring its weight to the adhesive to make it stick, without having to press it into the surface.

The third challenge is moving the nonengaged adhesive pad up the wall during the “swing” phase of the gait. While controllability allows the easy engagement and release of the adhesive, it does not mean that the adhesive does not stick when sheared in the anti-preferred direction. In fact, a limit curve of the microwedges shows nearly symmetric performance in force space (see FIG. 4). This is because the wedges simply flip, and the back of the wedge adheres. If the anisotropy ratio, α is defined as

$$α = \frac{{ShearAdhesion}_{non \text{-} preferred}}{{ShearAdhesion}_{preferred}} \qquad ( 1 )$$

and the hoist ability, H, as

$$H = \frac{{Payload}_{max}}{BodyWeight} , \qquad ( 2 )$$

then the hoisting ability of the robot, H, and consequently the Factor of Safety (F.S.) without a load, can be written as

$$H = F . S . = ( 1 - α ) \frac{{ShearAdhesion}_{preferred}}{BodyWeight} . \qquad ( 3 )$$

Without anisotropic adhesion (α=1), a robot using a 1 DOF linear inchworm gait could not climb, nor carry a load. Decreasing α linearly increases the hoisting capability, H. Two methods are presented herein for achieving relatively high values of α, one mechanical (for the 9 g robot) and one at the adhesive level (for the 20 mg climber).

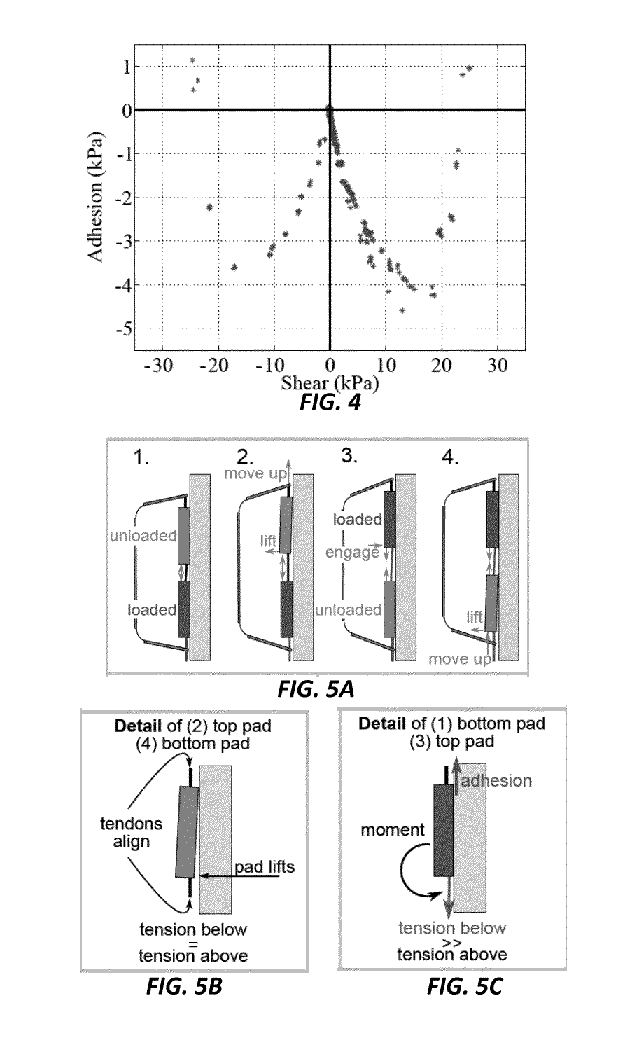

For the 9 g climber, the scale is large enough to use a mechanical solution in order to decrease adhesion while the pad moves up the wall. The bottom of the unloaded adhesive pad is brought away from the wall as a result of carefully selected tendon attachment points (see FIG. 5B). The upper tendon is attached to the pad further from the climbing surface than the lower tendon. When the tension is equal in both tendons, the two tendons align, rotating the pad away from the wall. In contrast, when the tension in the lower tendon is much greater than that in the upper tendon, the pad begins to move down the wall, the adhesive at the top of the pad engages, and a moment results. This moment is due to the upward shear adhesion acting on the pad at the surface while the downward tendon tension acts at a distance from the surface.

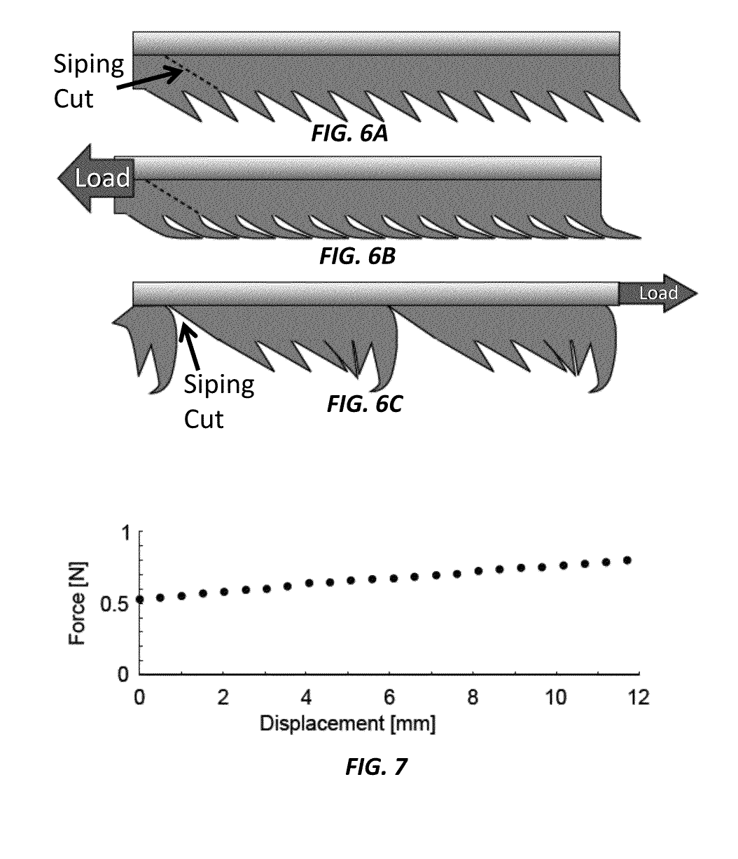

While such a design works at the centimeter scale, it is very difficult at the scale of the 20 mg climber. The current invention decreases the area of adhesive in contact with the surface when the pad is pulled in the non-preferred direction, and is compatible with a sub-centimeter pad. The current invention uses siping, which includes making small, angled cuts in the adhesive (see FIGS. 6A-6C). The cuts in the PDMS behind the microwedges do not alter performance when loaded in the preferred direction (see FIG. 6B), but allow for a greatly reduced shear adhesion in the non-preferred direction. While such one-way adhesion has been previously reported with stiff angled fibers, this method makes one-way adhesion available for softer dry adhesives, and shows smaller values of α.

In order to move the upper pad up the wall while unloaded, a return spring is required. Ideally it would be a constant force spring, applying just enough force to slide the pad up the wall. Any additional force in the spring would need to be overcome by the actuator while bringing the pads together. The force-displacement curve of the designed preloaded bow spring shows the desired small change in force across the 10 mm of travel in the spring (see FIG. 7).

These three design choices, namely a rigid adhesive pad loaded by a tendon, a controllable adhesive, and an inchworm gait that exploits anisotropic adhesion, allow the creation of reduced complexity, light climbers with large hoisting abilities.

With the principles of the designs in place, two exemplary robots, according to the current invention, are provided: first the 9 g miniature robot, and second the 20 mg micro robot.

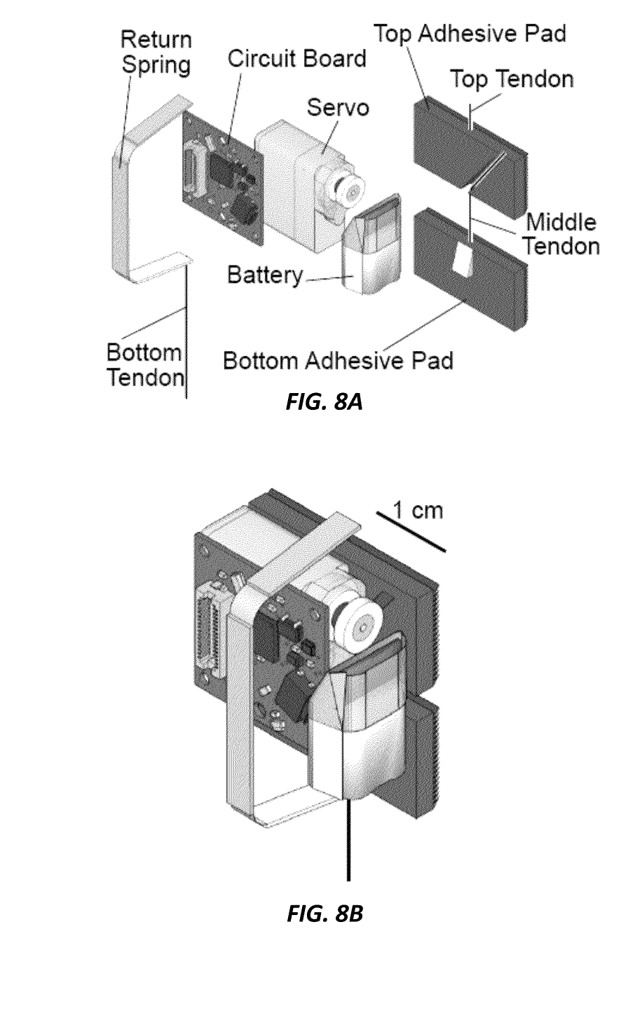

One embodiment of the 9 g climber is shown in FIGS. 8A-8B. The main components are the adhesive pads, the servo, the circuit board, the battery, the tendon, and the return spring (See Table. I). In this embodiment, the dimensions are 30 mm long, 25 mm wide, and 20 mm tall. The adhesive pads are laser machined from fiberglass sheet and directly cast with 80 μm tall microwedges on the contacting face. The servo is attached to the top pad with cyanoacrylite adhesive. The circuit board is mounted to the servo with double-sided foam tape, while the battery is attached directly to the top pad, next to the servo. The top tendon is attached to the adhesive pad via a machined hole in the top of the pad and to the return spring via a hole in its end. The return spring is made from 0.7 mm thick Delran, machined by laser, with a section of carbon-fiber bonded to the central portion to give it a squared off shape. The middle tendon is mounted to the a servo horn that is machined into a spool shape. It then passes through a machined hole in the bottom of top pad into a machined hole in the top of the lower pad, where it is fixed. The bottom tendon passes from a machined hole in the bottom pad to the load.

TABLE I
Specs for the 9 g climber.

| | | |
|---|---|---|
| Adhesive | Material | Fiberglass, PDMS adhesive |
| Pads | Size (L × W × H) | 10 mm × 25 mm × 3 mm |
| (3 g) | Max Load | 12 N |
| | Adhesive Cycle Speed | ~15 Hz |
| Servo/ | Name | Hitec HS-5035HD |
| Winch | Max Load/Cycle Work | 35 N/0.25 J/stroke |
| (3 g) | Max Cycle Rate | ~1.5 Hz |
| | Operating Effciency | ~20% under half load |
| Processor | ATMega 328P | 8 MHz (“TinyLily”) |
| (1 g) | Inputs/Outputs | 8 |
| Battery | Type | Lithium-Polymer |
| (1 g) | Capacity | 500 J (3.7 V, .040 Amp hr.) |
| Spring | Material | Delrin (0.7 mm thick) with Brass |
| (1 g) | Nominal Spring Force | ~0.6 N |
| Tendon | Material | Spectra (0.28 mm Braided) |
| | Max Load | 140 N |
| Assembled | Mass | 9 g |
| Robot | Size (L × W × H) | 30 mm × 25 mm × 20 mm |
| (9 g) | Step Size/Step Rate | 12 mm/1.5 Hz (Servo Limited) |
| | Speed | 0.6 body-lengths/s/1.8 cm/s |
| | Max Payload: Weight | >100:1 |
| | Max Climbing Height | 4 m (theoretical, 1 kg payload) |

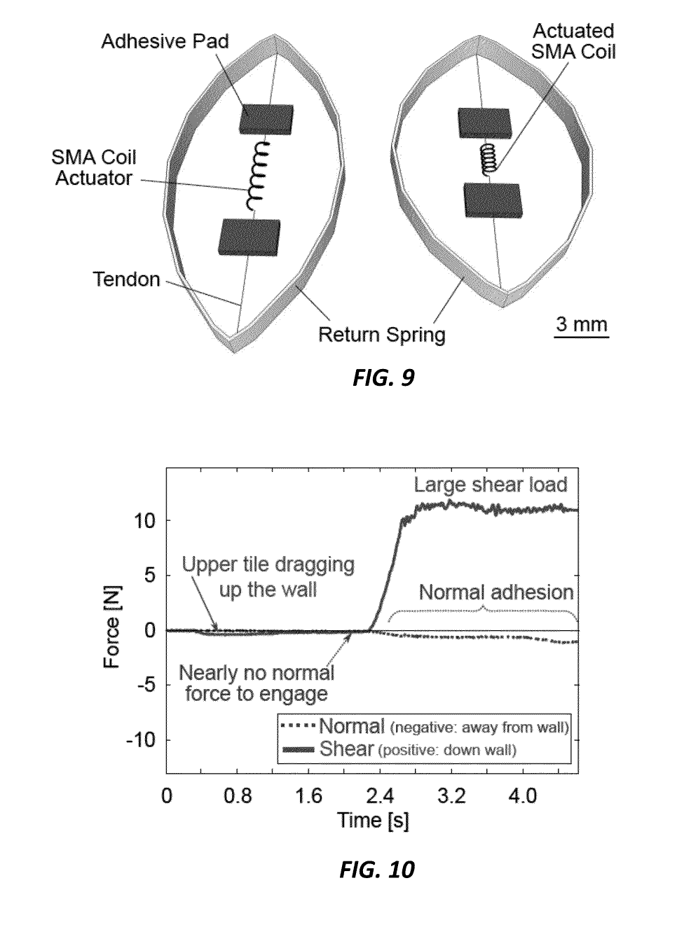

Another exemplary embodiment of a micro climber is detailed in FIG. 9. This climber shows that the gait can be scaled to much smaller robots (this climber is nearly 3 orders of magnitude less massive than the servo driven robot). It comprises two adhesive pads, a coiled spring Shape Memory Alloy (SMA) actuator, tendons, and a return spring (See Table II). The adhesive pads are again constructed from fiberglass with microwedge adhesive. Small holes are machined in the top and bottom of each pad, into which Spectra strands (tendons) are passed and fixed with cyanoacrylite. The return spring is made from two pieces of 0.4 mm thick, 1.5 cm long, 2 mm tall fiberglass rectangles attached at the ends with a kevlar flexure. The top tendon passes from the kevlar joint in the return spring the top pad. Another tendon passes from the top pad to the coiled SMA, and a third tendon connects the SMA to the bottom pad. The bottom tendon connects the bottom pad to the bottom of the return spring. Loads are applied through the bottom tendon. The climber does not have onboard power, but instead is activated by a nearby resistive heat source.

TABLE II
Specs for the 20 mg climber.

| | | |
|---|---|---|
| Adhesive Pads | Material | Fiberglass, PDMS adhesive |
| | Size (L × W × H) | 3 mm × 2 mm × 0.7 mm |
| | Max Load | 0.07 N |
| | Max Cycle Rate | ~15 Hz |
| Actuator | Type | Shape Memory Alloy |
| | Wire diameter | 0.1 mm |
| | Coil Diameter | 0.4 mm |
| | Max Force | 0.15 N |
| | Max Stroke | 1.5 mm |
| | Max Cycle Rate | ~1 Hz (no active cooling) |
| Power Source | Type | Heat (external) |
| Spring | Material | Fiberglass (0.4 mm), Kevlar |
| | Spring Force | .04 N |
| Tendon | Material | Spectra (0.02 mm flament) |
| Assembled | Size (L × W × H) | 12 mm × 9 mm × 1.5 mm |
| Robot | Mass | 20 mg |
| | Step Size | 0.8 mm |
| | Step Rate | 1 Hz (Actuator Limited) |

A series of tests were done to help characterize the gait and the climbers, including a test if the anisotropy ratio, α of the 9 g climber, the robot with a 1 kg payload, was made to step onto a sensorized section of a vertical wall. The section was supported by an ATI-Gamma 6-axis force-torque sensor reordering at 500 Hz. The results of the test are shown in FIG. 10. In the perpendicular direction, approximately 1N of force can be seen as the pad moves up along the sensor. When divided by the shear adhesion ability of a pad (21 N), an α value of 0.083 is calculated (Table III). Such a low α value allows the large hoisting ability, H.

TABLE III
Anisotropic adhesion data for various adhesives and configurations.

| | | Peak Non- | | Hoisting | Effective |
|---|---|---|---|---|---|
| | | Preferred | Anisotropy | Ability, H | Adhesive |
| Adhesive Type | Shear Stress | Shear Stress | Ratio, α | (body weights) | Loss |
| Flat, Smooth PDMS | High | High | 1 | 0 | 100% |
| | | (Isotropic) | | | |
| Standard | 70 kPa | 51 kPa | 0.73 | 58 | 73% |
| Controllable | | | | | |
| Adhesive | | | | | |
| Controllable | 70 kPa | N/A | 0.083 | 196 | 8% |
| Adhesive | | (5.8 kPa | | | |
| Mechanical A.A. | | effective) | | | |
| Controllable | 70 kPa | 1.1 kPa | 0.016 | 211 | 2% |
| Adhesive | | | | | |
| Material A.A. | | | | | |
| Controllable | 70 kPa | 0 kPa | 0 | 223 | 0% |
| Adhesive | | | | | |
| Perfect A.A. | | | | | |

Mechanical A.A. (Anisotropic Adhesion) refers to the method used by the 9 g climber. Material A.A. refers to the siping method used in the 20 mg climber.

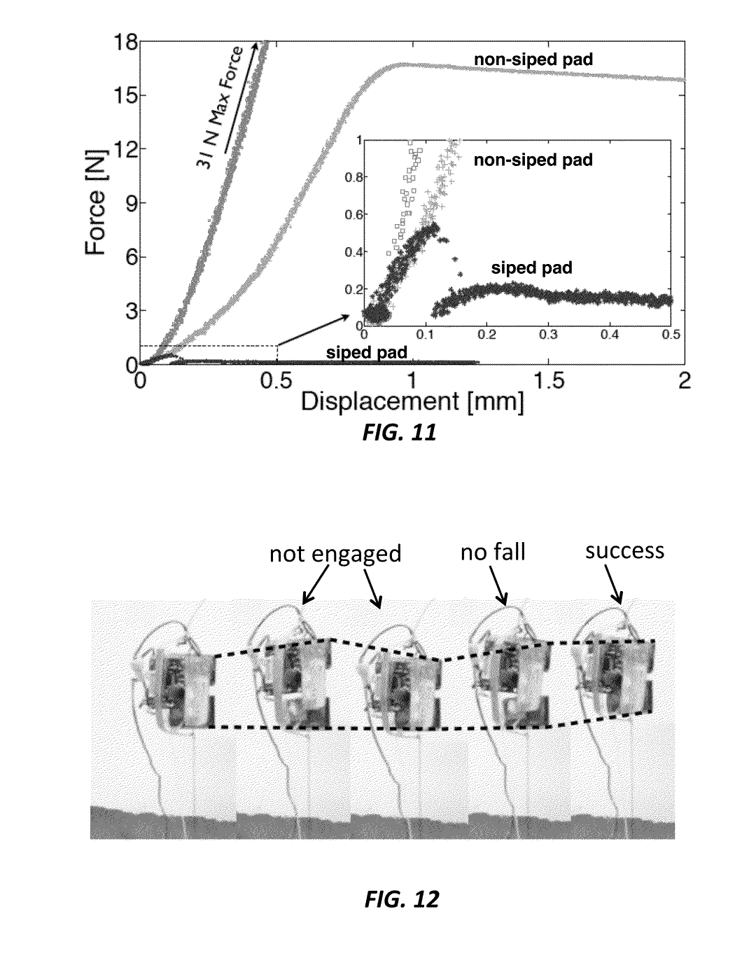

Anisotropy was also tested on for the siping method. Because it was unfeasible to test the 20 mg climber, a 2.5×2.5 cm adhesive pad was tested. The pad was placed on a flat glass surface and loaded through a tendon with an Aurora Muscle Lever 309C, which recorded force and displacement data. Results are shown in FIG. 11. While siping does not significantly effect the ability of the adhesive in the preferred direction (Pvalue=0.9), in the non-preferred direction, a substantial difference is observed. This is important not only in creating an α value of 0.016, but also for reducing wasted work during climbing. The area under the curves on the force-displacement plot represent work done by the robot while lifting a pad up the wall. The steady state non-preferred shear adhesion is less than 0.15 N, approximately 200 times less than the adhesive ability in the preferred direction (31 N).

The two potential limiters for the speed of the 9 g robot are the adhesives and the servo. Fibrillar adhesives, however, are relatively fast. Unlike a dry adhesive without features, for which the contact patch must spread across the adhesive area in a progressing line, fibrillar adhesives can break this single serial event into tens of thousands of parallel events. Therefore, the speed to both engage and disengage the fibrillar adhesive can be orders of magnitude faster. Experiments with flat PDMS peeled at 40 degrees from the glass surface have shown that with a peel force of 0.05N (half the robot's weight), peeling occurs at 1 mm/s. For flat PDMS, this would take 12 s to make it across a pad, but only 0.08 s to make it across all of the 90 μm contact patches of the microwedges in parallel (which each peels like a flat PDMS film). Since engagement happens at a similar rate, the predicted maximum frequency fₘₐₓ of the robot is

$${f}_{max} = \frac{1}{2 ( {t}_{eng} + {t}_{dis} )} \qquad ( 4 )$$

where t_{eng} is the time to fully engage and t_{dis} is the time to disengage. The factor of two results from the need to have both adhesive pads engage and disengage during each cycle. With t_{dis} roughly 0.08 s, and with the assumption that t_{eng} is roughly equivalent, fₘₐₓ is predicted to be less than 15 Hz. However, the limit of 50 Hz is never reached, because of the limit of the servo. The no load speed is 540″/s, and since the servo turns forward and back 180″/step, the max speed without load is 1.5 Hz. Experiments to measure speed and step size found roughly a 12 mm step and a speed of 18 mm/s, or 0.6 bodylengths/s. At full load of 1000 g, the robot was measured to climb at 3-4 mm/s, although the gait was not optimized for speed.

The 9 g climber shows very desirable characteristic in its robustness to a missed step (where the adhesive does not engage with the surface). In most climbing robots, a missed step is catastrophic, because the outgoing pad is peeled from the wall in order to press the incoming pad into contact. This means that if the incoming foot does not engage, the robot has no feet left in contact (in the case of a gait where only half of the feet are on the wall during stance—some climbing robots climbed with 6 feet and only removed one at a time). In contrast, the presented inchworm climbing gait is only able to release the outgoing foot by applying a shear force from the incoming foot. Therefore, if the incoming foot does not engage, the outgoing foot remains firmly planted, until a second step is attempted. Frames from a video in which the incoming foot is set up to fail on the first attempt shows the described robustness (FIG. 12).

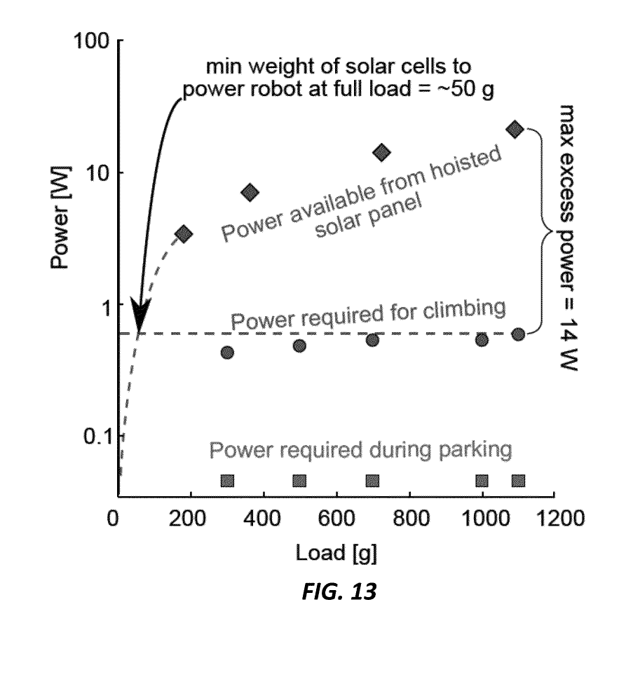

The 9 g climber displays a large ratio of load carrying ability to required power for climbing. In FIG. 13, the dots show the power consumed by the 9 g climber while hoisting loads from 300 to 1100 g. At a 1000 g payload, this ratio is roughly 2 kg/W. For reference, prior art attempts could manage 0.2 kg/W. As another comparison, the available power from an off-the-shelf solar system is plotted (diamonds). If the entire payload were panels, 14 W more power would be supplied than required for climbing. Alternatively, only roughly 50 g (5% of the load capacity) of solar panel is needed to carry a 1100 g payload. This leaves both the power to operate and the payload capability to carry significant tools and communication devices.

As another point of reference, if the entire payload were composed of non-rechargable lithium batteries, the robot could theoretically climb 10 km vertically. Obviously, the robot would not survive this number of steps, however, it is an informative metric for understanding the scale of the payload to power required ratio. The robot also demonstrates an ability to park while drawing no power from the actuator (FIG. 13, squares).

This capability is created through bypassing the actuator when transferring load to the bottom adhesive pad. The circuit board draws 0.04 W, but this can be set to sleep mode, decreasing the draw to 4 mW. Such an ability is beneficial for any environmental monitoring tasks that may require extended periods of time in a parked state.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art. For example the actuator that powers the climber could be pneumatic, hydraulic, piezoelectric, or any device that can do mechanical work. More than two adhesive pads could be used, and additional actuators could allow turning, climbing downwards, or allow the ability to step over obstacles.

All such variations are considered to be within the scope and spirit of the present invention as defined by the following claims and their legal equivalents.

What is claimed:

1. A one-way synthetic dry adhesive comprising:
a. a dry adhesive material layer comprising an array of microwedges, wherein said dry adhesive material layer is disposed on a substrate surface, wherein said microwedges comprise a leading surface and a trailing surface, wherein said leading surface terminates into said trailing surface to form a wedge tip, wherein said leading surface comprises an angle up to 90 degrees with respect to a said substrate surface, wherein said trailing edge surface comprises an angle greater than said leading surface angle with respect to said substrate surface, wherein said microwedges comprises a depth that is less than a thickness of said dry adhesive material layer; and
b. a series of siping features disposed in said dry adhesive material layer, wherein a depth of said siping features is greater than said microwedge depth, wherein said series of siping features has a periodicity that is less than a periodicity of said array of microwedges.

2. The one-way synthetic dry adhesive of claim 1, wherein said dry adhesive material is selected from the group consisting of Polydimethylsiloxane (PDMS), silicone rubbers, urethane rubbers, thermoplastics, and thermosetting polymers.

3. The one-way synthetic dry adhesive of claim 1, wherein said siping features comprise an angle that is up to 90 degrees with respect to said substrate surface.

4. The one-way synthetic dry adhesive of claim 1, wherein said siping feature is closed when in a load-state of said one-way synthetic dry adhesive, wherein said siping feature is open when in an unload-state of said one-way synthetic dry adhesive.

5. The one-way synthetic dry adhesive of claim 4, wherein when in said load-state said microwedges increase contact with a climbing surface with respect to a static state, wherein when in said unload-state said microwedges decrease contact with said climbing surface with respect to said static state.

6. The one-way synthetic dry adhesive of claim 1 further comprises a connector spanning from said substrate to a second substrate of a second said one-way synthetic dry adhesive.

7. The one-way synthetic dry adhesive of claim 6, wherein said connector is selected from the group consisting of an elastic tendon, a spring, a 1-dimensional actuator, a motor, and a linkage.
